(19) United States
(12) Patent Application Publication
(10) Pub. No.: US 2007/0051473 A1
(43) Pub. Date: Mar. 8, 2007

(54) Lable made of polyester fibers, and installation for production thereof

(75) Inventor: Francisco Speich, Gipf-Oberfrick (CH)

Correspondence Address: Wolf & Samson, One Boland Drive, West Orange, NJ, 07052, US

(73) Assignee: TEXTILMA AG, Hergiswil (CH)

(21) Appl. No.: 10/557,593

(22) PCT Filed: Mar. 5, 2004
(86) PCT No.: PCT/CH04/00133

§ 371 Date: Jun. 5, 2006

(30) Foreign Application Priority Data
May 20, 2003 (CH) 900/03

(51) Int. Cl. B65C 11/02

(52) U.S. Cl. 156/384

(57) ABSTRACT

Disclosed is a label that is made of polyester fibers and comprises a transponder (8) which is disposed between two layers of fabric (4, 6). Said layers of fabric are connected to each other at least on two opposite sides (10,12). In order to be able to produce the inventive label in a simple manner, the layers of fabric (4, 6) are produced independently and are connected to each other at least on the two opposite sides (10,12) at least by means of spot welding (14, 16).

### TECHNICAL FIELD

The invention relates to a label made of polyester fibers according to the precharacterizing clause of claim 1 and to an installation for the production thereof according to the precharacterizing clause of claim 8.

### PRIOR ART

A label of the type mentioned at the beginning is known for example from WO 94/29503. The label comprises two layers of fabric which are woven to each other along the longitudinal sides and between which a transponder is arranged. To produce this label, a strip is produced in a weaving machine, which strip is formed with two layers, at least in certain regions, and forms a cavity in between, which is created in sections in at least two partial steps. In the first partial step, a beginning section of the piece of web is formed with an initially still open pocket in the double-layered region, the weaving process is stopped and the transponder is introduced into the interior of the pocket through the pocket opening. In a second partial step, an end section of the piece of web with a pocket closure is created in the double-layered region, completing the pocket with the transponder contained in it to form a closed cavity. Finally, the fabric web provided with the transponder is cut up into its individual pieces of web, that is to say labels. The cavity receiving the transponder may be joined on each of both sides by web extensions, which serve for fastening the label. Furthermore, the label may be provided with representations, such as graphic or alphanumeric information.

It is disadvantageous that the production of such a label is very complex, since on the one hand a double-layered strip has to be produced and the weaving process interrupted for the introduction of the transponder while the cavity is not yet closed. On the other hand, precautions must be taken on the weaving machine to make it possible for the transponder to be introduced into the cavity in the first place, i.e. the expanders and hold-down devices for guiding the fabric web that are customary for weaving machines cannot be used.

### SUMMARY OF THE INVENTION

The object of the invention is to provide a label and an installation for the production thereof with which the disadvantages mentioned are avoided.

The set object is achieved:
a) in the case of the label mentioned at the beginning by the characterizing features of claim 1;
b) by the installation according to claim 8.

The fact that the production of the label with the transponder takes place independently of the production of the two layers of fabric allows each production operation to be optimized in itself, i.e. the weaving process for the individual layers of fabric is no longer interrupted by the introduction of a transponder and the production of the label can be set up entirely for the introduction of the transponder between the two layers of fabric.

Advantageous refinements of the label are specified in claims 2 to 7 and advantageous refinements of the installation for the production thereof are specified in claims 9 to 14.

In principle, it is possible to delimit the cavity receiving the transponder only on two sides, preferably the longitudinal sides, and leave it open on the two other sides. More advantageous, however, is a refinement according to claim 2, according to which the fabric web are joined to each other on at least one further side by means of spot welding.

The spot welding of the layers of fabric brings the advantage that the joining seam is flexible and the label can therefore adapt itself better to unevennesses. Furthermore, a spot joining seam is softer and in this way increases the wearing comfort of the label where it is arranged in a garment. However, this does not preclude such a weld seam being formed if need be according to claim 3 as a continuous weld seam. It may possibly also be expedient to arrange a continuous weld seam in addition to a spot weld seam.

It may also possibly be expedient to provide a join that is provided by sewing, this being the case in particular on the transverse sides joining the longitudinal sides.

According to claim 4, at least one layer of fabric may be a strip with cut longitudinal edges. According to claim 5, at least one layer of fabric may also be formed as a strip with woven or knitted longitudinal edges.

The label may be substantially limited to the size of the installed transponder, but more advantageous is a form according to claim 6, according to which there are free strip sections extending from the transponder on opposite sides, preferably on the narrow sides. Such free strip sections may serve in particular for the fastening of the label to an object.

According to claim 7, at least one of the layers of fabric of the label may contain printed-on and/or woven-in or knitted-in representations. Such representations may serve for informative and/or decorative purposes.

The installation for producing the label has a bringing-together station, at which a first fabric strip, fed from a first supply device, and a second fabric strip, fed from a second supply device, can be brought into contact one on top of the other to enclose fed-in transponders. The bringing-together station is assigned joining devices for joining the fabric strips, at least in the region of the longitudinal edges of the fabric strips lying one on top of the other.

There are a wide variety of possibilities for the feeding of the transponders. Particularly preferred is a form according to claim 9, according to which one of the fabric strips has pre-mounted, for example adhesively attached, transponders. According to claim 10, the installation may also be equipped with a third supply device for transponders detachably fastened on a carrier material, which device has a transfer element, assigned to the bringing-together station, for transferring the transponders from the carrier material to the bringing-together station. It is also conceivable for a third supply device to contain a magazine for the transponders, from which a transfer element introduces transponders between the fabric strips.

According to claim 11, the feeding station may be assigned a joining device acting transversely in relation to the strip running direction, in order for example to close the cavity for the transponder at least on a third side.

According to claim 12, arranged downstream of the bringing-together station is a separating device, acting transversely in relation to the strip running direction, in order to cut off individual labels from the continuous label strip.

There are numerous refining possibilities for the refinement of the joining device on the one hand and the separating device on the other hand. The joining device may, for example, be a sewing device. Also conceivable is an ultrasonic device for welding the strips of fabric together. Particularly preferred, however, is the form of a joining device according to claim 13 as a laser gun.

There are also a wide variety of forming possibilities for the separating device, which apart from mechanical shears may comprise in particular a thermal cutting device. Particularly preferred is the form according to claim 14 as a laser gun. The thermal devices not only bring about severing of the fabric webs but also make it possible in particular for the cut edges to be welded and for them to be joined between the fabric strips.

### BRIEF DESCRIPTION OF THE DRAWINGS

Exemplary embodiments of the invention are described in more detail below on the basis of the drawings, in which:

FIG. 1 shows a first label in plan view;

FIG. 2 shows the label of FIG. 1 in section II-II;

FIG. 3 shows a second label in plan view;

FIG. 4 shows a first installation for the production of the label in a schematic representation and in side view; and

FIG. 5 shows a second installation for the production of the label in a schematic representation and in side view.

### WAYS OF IMPLEMENTING THE INVENTION

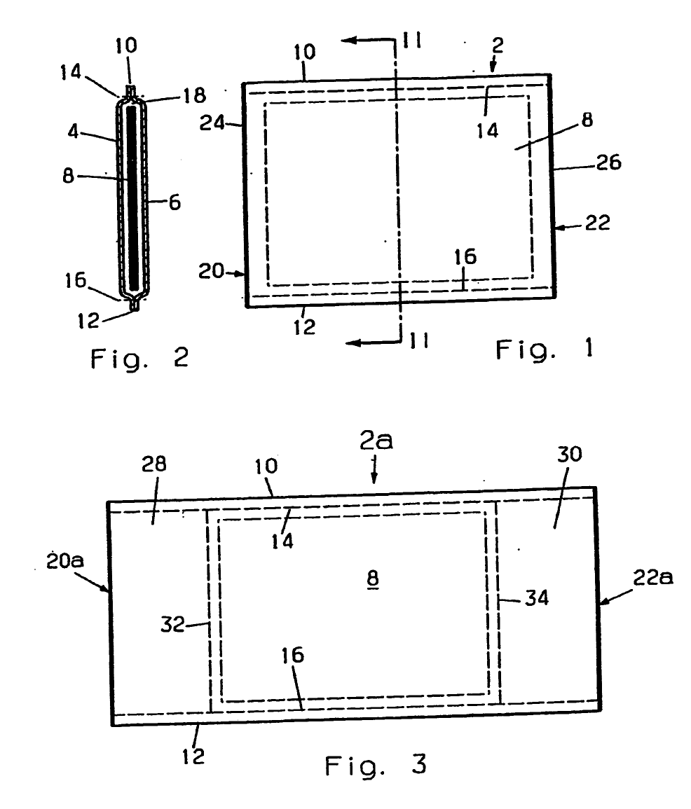

FIGS. 1 and 2 show a first label 2, which contains a transponder 8 between a first layer of fabric 4 and a layer of fabric 6. At the longitudinal edges 10, 12, the layers of fabric 4, 6 are joined to each other by means of spot weld seams 14, 16 and form a cavity 18, in which the transponder 8 is arranged. On the transverse sides 20, 22, the layers of fabric 4, 6 are thermally cut, thereby creating weld seams 24, 26, which can join the layers of fabric 4, 6 to each other.

The label 2a shown in FIG. 3 corresponds substantially to the label 2 shown in FIGS. 1 and 2, although the transponder 8 or the cavity 18 is adjoined in the longitudinal direction by strip sections 28, 30 which are free from the transponder 8 and serve in particular for fastening the label to an underlying surface. To delimit the cavity 18, transverse seams 32, 34 are arranged on the transverse sides 20a, 22a. The transverse seams 32, 34 may be formed by a mechanical sewing operation, or else by spot-type or continuous weld seams. At least one of the layers of fabric may be provided in a way that is not represented any more specifically but is known with printed-on and/or woven-in or knitted-in representations, which may serve either decorative and/or informative purposes.

A transponder is generally a data carrier, which usually includes a transmitting and receiving unit and a microchip. Some transponders additionally have a voltage supply of their own. Such transponders may be designed and used for a wide variety of tasks. A widely known area is that of protecting products sold in the retail trade from theft and use in logistics.

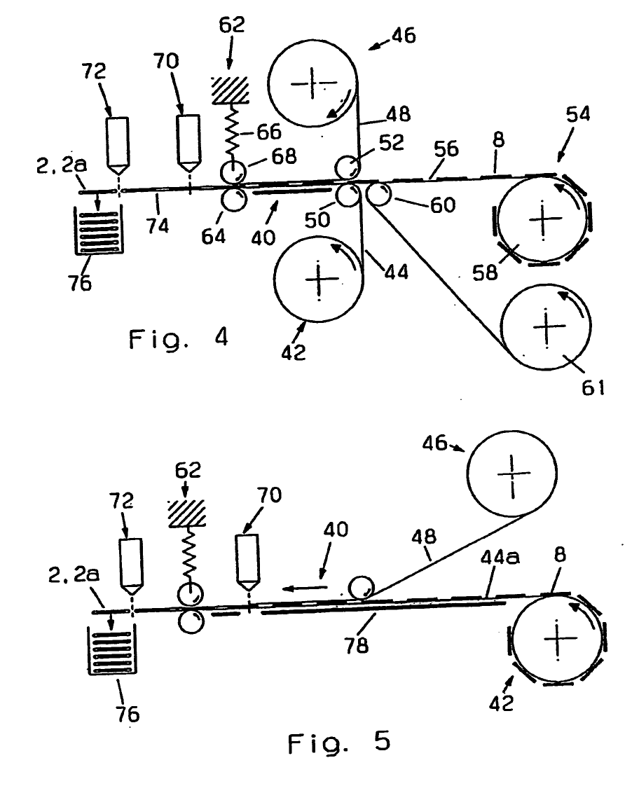

FIG. 4 shows a first installation for producing the label 2, 2a. It has a bringing-together station 40, which is assigned a first supply device 42 for a first fabric strip 44 and a second supply device 46 for a second fabric strip 48. The supply devices 42, 46 are arranged under and over the bringing-together station 40, deflecting rolls 50, 52 serving for the partial alignment of the two fabric strips 44, 48. The installation includes a third supply device 54, which draw transponders 8, arranged on a carrier material 56, from a supply roll 58 and feed them to the bringing-together station 40, the transfer element 60 formed as a roll sharply deflecting the carrier material 56 in such a way that the transponders 8 are delivered to the bringing-together station 40 between the fabric strips 44, 48. The free carrier material 56 is wound up to form a take-up roll 61.

A transporting device 62, comprising a supporting roller 64 and a pressing roller 68, pressed by means of a spring device 66, at least one of which rollers is driven, provide the transporting of the brought-together fabric strips. Respectively provided at the longitudinal edges is a joining device 70, which is preferably formed as a laser gun and serves for joining the fabric strips 44, 48 at the longitudinal edges. A downstream separating device 72 cuts up the label strip 74 into individual labels 2, which are collected in a collecting container 76. The separating device 72, which is preferably likewise formed as a laser gun, serves not only for severing the label strip 74 but also at the same time for joining the first and second fabric strips 44, 48.

FIG. 5 describes a further installation, which is constructed in a way substantially analogous to the installation of FIG. 4, but the third supply device 54 is omitted and instead the first fabric strip 44a is already provided with pre-mounted transponders 8. The second, upper fabric strip 48 is then placed onto the first fabric strip 44a with the transponders 8, which lies on a rest 78. The fabric strips 44a, 48 are joined as described above.

List of Designations

List of designations

| | |
|---|---|
| 2 | label |
| 2a | label |
| 4 | first layer of fabric |
| 6 | second layer of fabric |
| 8 | transponder |
| 10 | longitudinal edge |
| 12 | longitudinal edge |
| 14 | spot weld seam |
| 16 | spot weld seam |
| 18 | cavity |
| 20 | transverse side |
| 20a | transverse side |
| 22 | transverse side |
| 22a | transverse side |
| 24 | weld seam |
| 26 | weld seam |
| 28 | strip section |
| 30 | strip section |
| 32 | transverse seam |
| 34 | transverse seam |
| 40 | bringing-together |
| | device |
| 42 | first supply device |
| 44 | first fabric strip |
| 44a | first fabric strip |
| 46 | second supply device |
| 48 | second fabric strip |
| 50 | deflecting roll |
| 52 | deflecting roll |
| 54 | third supply device |
| 56 | carrier material |
| 58 | supply roll |
| 60 | transfer element |
| 61 | take-up roll |
| 62 | transporting device |
| 64 | supporting roller |
| 66 | spring device |
| 68 | pressing roller |
| 70 | joining device |
| 72 | separating device |
| 74 | label strip |
| 76 | collecting container |
| 78 | rest |

1. A label made of polyester fibers, with a transponder (8) arranged between two layers of fabric (4, 6), the layers of fabric being joined to each other on at least two mutually opposite sides (10, 12), wherein the layers of fabric (4, 6, 44, 44a, 48) are produced independently of each other and are joined to each other, at least on the two mutually opposite sides (10, 12), at least by spot welding (14, 16).

2. The label as claimed in claim 1, wherein the layers of fabric (4, 6) are joined to each other on at least one further side (20a, 22a) at least by spot welding (32, 34).

3. The label as claimed in claim 1, wherein the layers of fabric (4, 6) are joined to each other at least partly by continuous weld seams (24, 26).

4. The label as claimed in claim 1, wherein at least one layer of fabric (4, 6) is formed from a fabric strip (44, 44a, 48) with cut longitudinal edges.

5. The label as claimed in claim 1, wherein at least one layer of fabric (4, 6) is formed from a fabric strip (44, 44a, 48) with woven or knitted longitudinal edges.

6. The label as claimed in claim 1, and further comprising strip sections (28, 30) which are free from the transponder (8) and arranged on opposite sides of the label.

7. The label as claimed in claim 1, wherein at least one of the layers of fabric (4, 6) contains printed-on and/or woven-in or knitted-in representations.

8. An installation for producing the label as claimed in claim 1, comprising a bringing-together station (40), at which a first fabric strip (44, 44a), fed from a first supply device (42), and a second fabric strip (48), fed from a second supply device (46), can be brought into contact one on top of the other to enclose fed-in transponders (8), the bringing-together station (40) being assigned joining devices (70) for joining the fabric strips (44, 48), at least in the region of the longitudinal edges (10, 12) of the fabric strips lying one on top of the other.

9. The installation as claimed in claim 8, wherein one of the fabric strips (44a) has pre-mounted, transponders (8).

10. The installation as claimed in claim 8, further comprising a third supply device (54) for transponders (8) detachably fastened on a carrier material (56), which device has a transfer element (60), assigned to the bringing-together station (40), for transferring the transponders (8) from the carrier material (56) to the bringing-together station (40).

11. The installation as claimed in claim 8, wherein the bringing-together station (40) is assigned a joining device acting transversely in relation to the strip running direction.

12. The installation as claimed in one claim 8, wherein arranged downstream of the bringing-together station (40) is a separating device (72), acting transversely in relation to the strip running direction.

13. The installation as claimed in claim 8, wherein the joining device (70) is formed as a laser gun.

14. The installation as claimed in claim 12, wherein the separating device (72) is formed as a laser gun.

15. The label as claimed in claim 6, wherein the strip sections are on narrow sides of the label.

16. The installation as claimed in claim 9, wherein the transponders are adhesively attached to the fabric strips.
